(19) United States
(12) Patent Application Publication
(10) Pub. No.: US 2005/0005126 A1
(43) Pub. Date: Jan. 6, 2005

(54) Method and apparatus for generating and verifying an ID_based proxy signature by using bilinear pairings

(75) Inventors: Fangguo Zhang, Daejeon (KR); Kwangjo Kim, Daejeon (KR); Hyunggi Choi, Daejeon (KR)

Correspondence Address: BACON & THOMAS, PLLC, 625 SLATERS LANE, FOURTH FLOOR, ALEXANDRIA, VA, 22314, US

(73) Assignee: Information and Communications University Educational Foundation, Seoul (KR)

(21) Appl. No.: 10/747,188

(22) Filed: Dec. 30, 2003

(30) Foreign Application Priority Data
Jul. 4, 2003 (KR) 10-2003-0045217

(51) Int. Cl. H04L 9/00

(52) U.S. Cl. 713/176

(57) ABSTRACT

In a method and an apparatus for generating and verifying an identity based proxy signature by using bilinear pairings, a trust authority generates system parameters and selects a master key. Further, the trust authority generates private keys of an original signer and proxy signer based on the original signer's identity and the proxy signer's identity, respectively. The original signer generates a signed warrant, computes values for verifying the signature of the signed warrant and then transfers the signed warrant and the values to the proxy signer. Thereafter, the proxy signer verifies the signature of the signed warrant and then generates a proxy signature key. Finally, the proxy signer signs a delegated message and the verifier verifies the proxy signature.

### FIELD OF THE INVENTION

The present invention relates to a cryptographic system; and, more particularly to, a method and apparatus for generating and verifying an identity (ID) based proxy signature by using bilinear pairings.

### BACKGROUND OF THE INVENTION

In a public key cryptosystem, each user may possess two keys, i.e., a private key and a public key. A binding between the public key (PK) and the identity (ID) of a user is obtained via a digital certificate. In such a certificate-based public key system, however, before using the public key of the user, a participant must first verify the certificate of the user. As a consequence, a large amount of computing time and storage is required in this system because of its need to store and verify each user's public key and the corresponding certificate.

In 1984, Shamir published ID-based encryption and signature schemes to simplify key management procedures in a certificate-based public key setting (A. Shamir, “Identity-based cryptosystems and signature schemes”, Advances in Cryptology-Crypto 84, LNCS 196, pp.47-53, Springer-Verlag, 1984.). Since then, many ID-based encryption schemes and signature schemes have been proposed. The main idea of ID-based cryptosystems lay in using the identity information of each user works as his or her public key; that is, the user's public key may be calculated directly from his or her identity rather than being extracted from a certificate issued by a certificate authority(CA).

Therefore, the ID-based public key setting need not perform such processes as transmission of certificates and verification of certificates needed in the certificate-based public key settings. The ID-based public key settings may be an alternative to the certificate-based public key settings, especially when efficient key management and moderate security are required.

The bilinear pairings, namely the Weil pairing and the Tate pairing of algebraic curves, are important tools for researching algebraic geometry. Early applications of the bilinear pairings in cryptography focused on resolving discrete logarithm problems. For example, the MOV (Meneze-Okamoto-Vanstone) attack (using the Weil pairing) and FR (Frey-Ruck) attack (using the Tate pairing) reduce the discrete logarithm problems on certain elliptic or hyperelliptic curves to the discrete logarithm problems in a finite field. Recently, the bilinear pairings have found various applications in cryptography as well.

Specifically, the bilinear pairings are basic tools for constructing the ID-based cryptographic schemes and many ID-based cryptographic schemes have been proposed using them. Examples of using the bilinear pairings in ID-based cryptographic schemes include: Boneh-Franklin's ID-based encryption scheme (D. Boneh and M. Franklin, “Identity-based encryption from the Weil pairing”, Advances in Cryptology-Crypto 2001, LNCS 2139, pp.213-229, Springer-Verlag, 2001.), Smart's ID-based authentication key agreement protocol (N. P. Smart, “Identity-based authenticated key agreement protocol based on Weil pairing”, Electron. Lett., Vol.38, No.13, pp.630-632, 2002.), and several ID-based signature schemes.

The idea of using proxy signature was introduced by Mambo, Usuda and Okamoto (M. Mambo, K. Usuda, and E. Okamoto, Proxy signature: Delegation of the power to sign messages, IEICE Trans. Fundamentals, Vol. E79-A, No. 9, September, pp. 1338-1353, 1996.). A proxy signature scheme comprises three entities: an original signer, a proxy signer and a verifier. If the original signer wants to delegate signing capability to the proxy signer, the original signer uses an original signature key to create a proxy signature key which will then be sent to the proxy signer. The proxy signer may then use the proxy signature key to sign messages on behalf of the original signer. The verifier may be convinced that the signature is generated by an authorized proxy signer of the original signer.

There are three types of delegation: full delegation, partial delegation and delegation by warrant. After Mambo et al.'s first scheme was announced, many proxy signature schemes have been proposed. S. Kim et al., for example, gave a new type of delegation called partial delegation with warrant (S. Kim, S. Park, and D. Won, Proxy signatures, revisited, ICICS '97, LNCS 1334, Springer-Verlag, pp. 223-232, 1997.), which may be considered as a combination of the partial delegation and the delegation by warrant. In the present invention, an ID-based proxy signature scheme using the partial delegation with warrant is provided.

### SUMMARY OF THE INVENTION

It is, therefore, a primary object of the present invention to provide a method and apparatus for generating an identity based proxy signature by using bilinear pairings. In accordance with one aspect of the present invention, there is provided a method for generating and verifying an identity-based proxy signature by using bilinear pairings, comprising the steps of: (a) generating system parameters, selecting a master key and then disclosing the system parameters by a trust authority; (b) generating private keys of an original signer and proxy signer based on the original signer's identity and proxy signer's identity, respectively, and then transferring the original signer's private key and proxy signer's private key to the original signer and proxy signer, respectively, through a secure channel by the trust authority; (c) receiving and storing the system parameters and the original signer's private key by the original signer, receiving and storing the system parameters and the proxy signer's private key by the proxy signer and receiving and storing the system parameters by a verifier; (d) generating a signed warrant, computing values for verifying the signature of the signed warrant by using at least one of the system parameters and then transferring the signed warrant and the values to the proxy signer by the original signer; (e) verifying the signature of the signed warrant by using the values and an original signer's public key based on the original signer's identity and then generating a proxy signature key by the proxy signer; (f) proxy-signing a delegated message by using the proxy signature key by the proxy signer; and (g) verifying the validity of the proxy signature by using at least one of the system parameters and a proxy signer's public key based on the proxy signer's identity by the verifier.

In accordance with another aspect of the present invention, there is provided an apparatus for generating and verifying an identity-based proxy signature by using bilinear pairings, comprising: means for generating system parameters, selecting a master key and then disclosing the system parameters by a trust authority; means for generating private keys of an original signer and proxy signer based on the original signer's identity and proxy signer's identity, respectively, and then transferring the original signer's private key and proxy signer's private key to the original signer and proxy signer, respectively, through a secure channel by the trust authority; means for receiving and storing the system parameters and the original signer's private key by the original signer, receiving and storing the system parameters and the proxy signer's private key by the proxy signer and receiving and storing the system parameters by a verifier; means for generating a signed warrant, computing values for verifying the signature of the signed warrant by using at least one of the system parameters and transferring the signed warrant and the values to the proxy signer by the original signer; means for verifying the signature of the signed warrant by using the values and an original signer's public key based on the original signer's identity and then generating a proxy signature key by the proxy signer; means for proxy-signing a delegated message by using the proxy signature key by the proxy signer; and means for verifying the validity of the proxy signature by using at least one of the system parameters and a proxy signer's public key based on the proxy signer's identity by the verifier.

### BRIEF DESCRIPTION OF THE DRAWINGS

The above and other objects and features of the present invention will become apparent from the following description of preferred embodiments given in conjunction with the accompanying drawings, in which:

FIG. 1 shows a block diagram for explaining interaction among participants of a proxy signature system in accordance with a preferred embodiment of the present invention;

FIG. 2A shows a block diagram explaining a process of generating system parameters and keys of the system in accordance with a preferred embodiment of the present invention;

FIG. 2B is a block diagram showing a process of generating a proxy signature key of the system;

FIG. 2C provides a block diagram showing a process of verifying a proxy signature of the system; and

FIG. 3 is a flow chart showing an operation of the system for generating and verifying an ID-based proxy signature by using bilinear pairings.

### DETAILED DESCRIPTION OF THE PREFERRED EMBODIMENTS

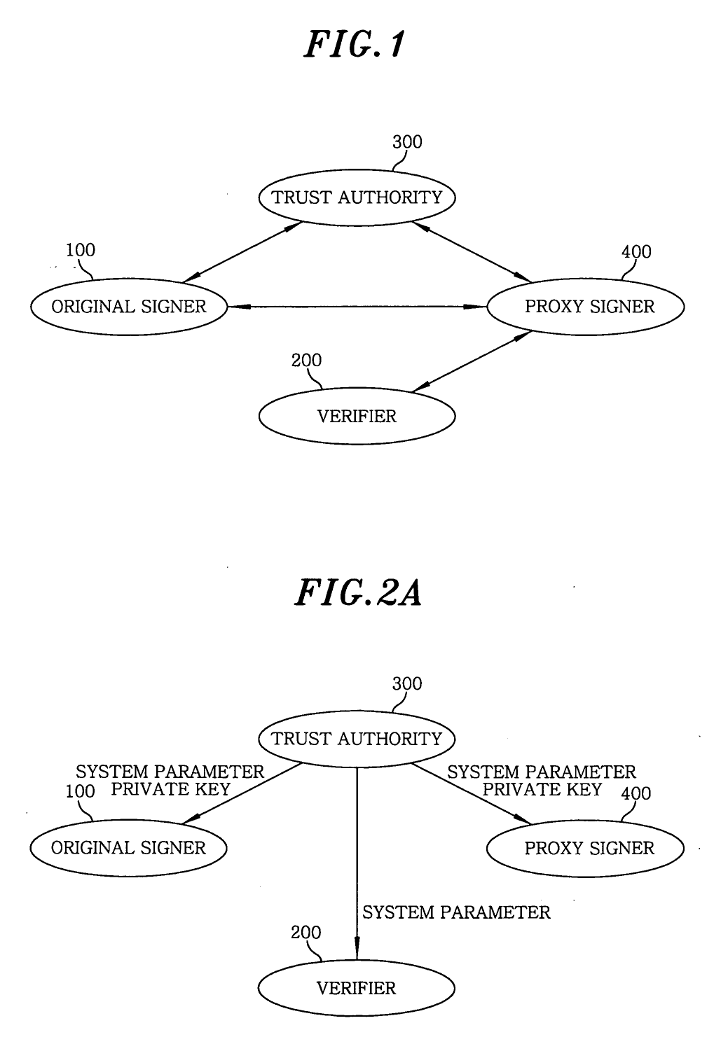

FIG. 1 shows interaction among participants of a system for generating and verifying an ID-based proxy signature by using bilinear pairings in accordance with an embodiment of the present invention. The system may include four participants, i.e., an original signer 100, a verifier 200, a trust authority 300 and a proxy signer 400. Each of these participants of the system can involve computer systems and may communicate with each other remotely by using any kind of communications network or techniques. The information to be transferred among the participants may be stored or be held in various types of storage media.

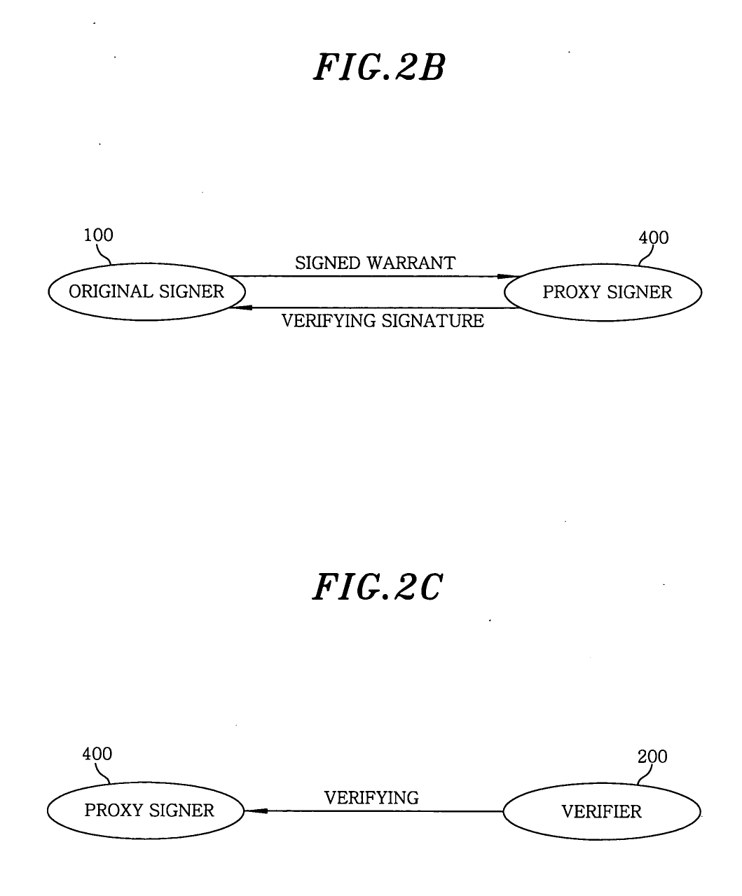

Referring to FIG. 2A, a process of generating system parameters and keys in accordance with the embodiment of the present invention is shown. The trust authority 300 may generate system parameters and select a master key. Further, the trust authority 300 may generate private keys of the original signer 100 and the proxy signer 400 by using the original signer's identity and the proxy signer's identity, respectively. Then, the trust authority 300 may disclose or publish the system parameters and transfers the original signer's private key and the proxy signer's private key to the original signer 100 and the proxy signer 400, respectively, through a secure channel.

The original signer 100 may receive the system parameters and the original signer's private key provided by the trust authority 300. Then the original signer 100 may store or hold them in a storage media.

Meanwhile, the proxy signer 400 may receive the system parameters and the proxy signer's private key provided by the trust authority 300. Then the proxy signer 400 may store or hold them in a storage media.

Meanwhile, the verifier 200 may receive the system parameters provided by the trust authority 300 which is stored or held in a storage media.

FIG. 2B shows a process for generating a proxy signature key between the original signer 100 and the proxy signer 400. The original signer may generate a signed warrant, compute values for verifying the signature of the signed warrant and transfer the signed warrant and the values to the proxy signer. Thereafter, the proxy signer may verify the signature of the signed warrant and then generate a proxy signature key.

FIG. 2C shows a block diagram for explaining a step of verifying a proxy signature in accordance with a preferred embodiment of the present invention. The proxy signer 400 may sign a delegated message and the verifier may verify the proxy signature.

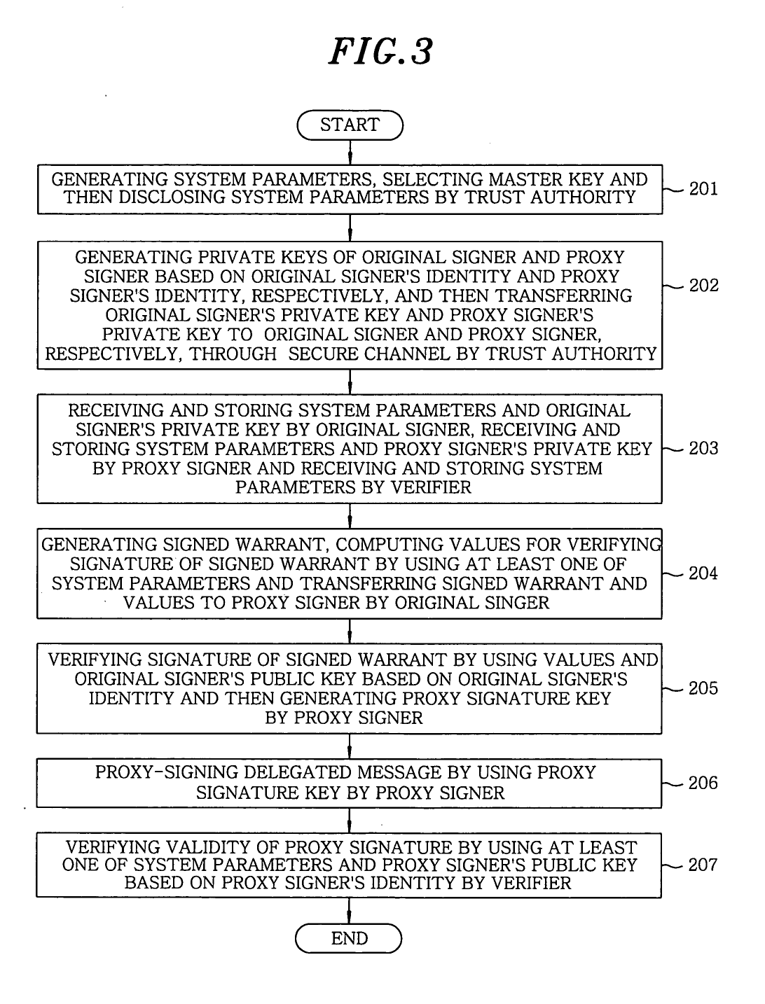

Referring now to FIG. 3, a detailed description of processes for generating and verifying an ID-based proxy signature by using bilinear pairings in accordance with a preferred embodiment of the present invention will be explained.

G₁ denotes a cyclic additive group generated by P, whose order is a prime q, and G₂ denotes a cyclic multiplicative group of the same order q. Discrete logarithm problems in both G₁ and G₂ are considered to be hard. Assuming e: G₁ ×G₁→G₂ is a pairing that may satisfy the following conditions:
1. Bilinear: e(aP, bQ)=e(P, Q)^{ab};
2. Non-degenerate: There exists P, Q ∈ G₁ such that e(P, Q) ≠ 1; and
3. Computability: There is an efficient algorithm to compute e(P, Q) for all P, Q ∈ G₁.

During a process of generating the system parameters and master key, which is performed by the trust authority 300, the cyclic groups G₁ and G₂ having order of q, respectively, may be generated. Then P (the generator of G₁) and e: G₁×G₁→G₂ (a pairing of the two cyclic group G₁ and G₂) may be generated. In the embodiment according to the present invention, G₁ is an elliptic curve group or hyperelliptic curve Jacobians and G₂ uses cyclic multiplicative group Z_{q}*. Then, the trust authority 300 selects an integer s belonging to Z_{q}* as a master key and computes P_{pub}=s·P. Additionally, the trust authority 300 selects hash functions H₁: {0,1}*→Z_{q}* and H₂: {0,1}*→G₁. Then, the trust authority 300 may disclose or publish the system parameters. More precisely, the trust authority 300 may disclose <G₁, G₂, e, q, P, P_{pub}, H₁ and H₂> as the system parameters that the original signer 100, the verifier 200 and the proxy signer 400 may share (step 201).

Thereafter, the trust authority 300 may generate the private keys of the original signer and the proxy signer based on the original signer's identity and the proxy signer's identity, respectively. If A is the original signer's identity, the original signer's private key may be S_{A}=s·Q_{A}, where Q_{A} is an original signer's public key described by Q_{A}=H₂(A). When B is the proxy signer's identity, the proxy signer's private key may be S_{B}=s·Q_{B}, where Q_{B} is a proxy signer's public key described by Q_{B}=H₂(B). Then, the trust authority 300 may transfer the original signer's private key and the proxy signer's private key to the original signer and the proxy signer, respectively, through a secure channel (step 202).

The original signer 100 may receive and store the system parameters and the original signer's private key. The proxy signer 400 may receive and store the system parameters and the proxy signer's private key. The verifier 200 may receive and store the system parameters (step 203).

During a process of generating the proxy signature, the original signer 100 may generate a signed warrant, compute values for verifying the signature of the signed warrant and transfer the signed warrant and the values to the proxy signer 400 (step 204).

The original signer 100 may use Hess's ID-based signature scheme (F. Hess, Efficient identity based signature schemes based on pairings, SAC 2002 LNCS 2595, pp. 310-324, Springer-Verlag, 2002.) to make a signed warrant m_{w}. Of course, another ID-based signature scheme may be selected as a basic signature scheme. There is an explicit description of a delegation relation in the warrant m_{w}. The original signer 100 may compute values for verifying the signature of the signed warrant. The original signer 100 may choose an integer k belonging to Z_{q}* and compute r_{A}=e(P, P)^{k}, c_{A}=H₁(m_{w}∥r_{A}) and U_{A}=c_{A}S_{A}+kP. Then, the original signer 100 may send (m_{w}, c_{A}, U_{A}) to the proxy signer 400.

In step 205, the proxy signer 400 may verify the validity of the signature on the signed warrant and then generate a proxy signature key. The proxy signer 400 may compute r_{A}=e(U_{A}, P)e(Q_{A}, P_{pub})^{-c}^{_{A}} and accept the signature only if c_{A}=H₁(m_{w}∥r_{A}). If the signature is valid, the proxy signer 400 may compute the proxy signature key S_{P}=c_{A}S_{B}+U_{A}.

Subsequently, in step 206, the proxy signer 400 may sign a delegated message using the proxy signature key S_{P}. The proxy signer 400 may use the Hess's ID-based signature scheme (taking S_{P} as a signing key) and obtain a signature (c_{P}, U_{P}) for any delegated message m. Here, (c_{P}, U_{P}) may be calculated by using equations, i.e., c_{P}=H₁(m∥r_{P}) and U_{P}=c_{P}S_{P}+k_{P}P, where r_{P} is r_{P}=e(P, P)^{k}^{_{P}} and k_{P} is an integer belonging to Z_{q}*. The valid proxy signature can be <m, c_{P}, U_{P}, m_{w} and r_{A}>.

During a process of verification in step 207, the verifier 300 may compute r_{P}=e(U_{P}, P) (e(Q_{A}+Q_{B}, P_{pub})^{H}^{₁}^{(m}^{_{w}}^{∥r}^{_{A}}⁾·r_{A})^{-C}^{_{P}} and accept the signature only if c_{P}=H₁(m∥r_{P}). The verification of the signature can be justified by following equations.

$$e ( {U}_{P} , P ) {( {e ( {Q}_{A} + {Q}_{B} , {P}_{pub} )}^{{H}_{1} ( {m}_{w} ‖ {r}_{A} )} \cdot {r}_{A} )}^{- {C}_{P}} = e ( {U}_{P} , P ) {( e ( {C}_{A} \cdot ( {S}_{A} + {S}_{B} ) , P ) \cdot {r}_{A} )}^{- {C}_{P}} = e ( {U}_{P} , P ) {( e ( {S}_{P} - kP , P ) \cdot {r}_{A} )}^{- {C}_{P}} = e ( {U}_{P} , P ) {( e ( {S}_{P} , P ) \cdot e ( - {k}_{P} , P ) \cdot {r}_{A} )}^{- {C}_{P}} = e ( {c}_{P} {S}_{P} + {k}_{P} P , P ) {e ( {S}_{P} , P )}^{- {C}_{P}} = e ( {k}_{P} P , P ) = {r}_{p}$$

A secure channel for delivery of the signed warrant is not required in the embodiment according to the present invention. More precisely, the original signer 100 may send (m_{w}, c_{A}, U_{A}) to the proxy signer 400 through a public channel; that is, any third adversary may get the original signer's signature on the warrant m_{w}. Forging the proxy signature on the message m' may be equivalent to forging a Hess's ID-based signature with a public key.

While the invention has been shown and described with respect to the preferred embodiments, it will be understood by those skilled in the art that various changes and modifications may be made without departing from the spirit and scope of the invention as defined in the following claims.

1. A method for generating and verifying an identity-based proxy signature by using bilinear pairings, comprising the steps of:
(a) generating system parameters, selecting a master key and then disclosing the system parameters by a trust authority;
(b) generating private keys of an original signer and a proxy signer based on the original signer's identity and the proxy signer's identity, respectively, and then transferring the original signer's private key and the proxy signer's private key to the original signer and the proxy signer, respectively, through a secure channel by the trust authority;
(c) receiving and storing the system parameters and the original signer's private key by the original signer, receiving and storing the system parameters and the proxy signer's private key by the proxy signer and receiving and storing the system parameters by a verifier;
(d) generating a signed warrant, computing values for verifying the signature of the signed warrant by using at least one of the system parameters and then transferring the signed warrant and the values to the proxy signer by the original signer;
(e) verifying the signature of the signed warrant by using the values and an original signer's public key based on the original signer's identity and then generating a proxy signature key by the proxy signer;
(f) proxy-signing a delegated message by using the proxy signature key by the proxy signer; and
(g) verifying the validity of the proxy signature by using at least one of the system parameters and a proxy signer's public key based on the proxy signer's identity by the verifier.

2. The method of claim 1, wherein the system parameters include G₁, G₂, e, q, P, P_{pub}, H₁ and H₂, where G₁ is a cyclic additive group whose order is a prime q, G₂ is a cyclic multiplicative group of the same order q, e is a bilinear paring defined by e: G₁×G₁→G₂, P is a generator of G₁, P_{pub} is a trust authority's public key having relationship of P_{pub}=s·P, where s is the master key, and H₁ and H₂ are hash functions, respectively, described by H₁: {0,1}*→Z_{q}* and H₂: {0,1}*→G₁, where Z_{q}* is a cyclic multiplicative group.

3. The method of claim 2, wherein the original signer's public key Q_{A} equals H₂(A), where A is the original signer's identity, and the original signer's private key S_{A} equals s·Q_{A}; and
the proxy signer's public key Q_{B} equals H₂(B), where B is the proxy signer's identity, and the proxy signer's private key S_{B} equals S_{B}=s·Q_{B}.

4. The method of claim 3, wherein in the step (d), the signed warrant m_{w} contains an explicit description of a delegation relation, the values for verifying the signature of the signed warrant (c_{A}, U_{A}) have the relationship of c_{A}=H₁(m_{w}∥r_{A}) and U_{A}=c_{A}S_{A}+kP, respectively, where r_{A} equals e(P, P)^{k} and k is an integer belonging to Z_{q}*.

5. The method of claim 4, wherein the verifying step (e) accepts the signature only if c_{A}=H₁(m_{w}∥r_{A}), where r_{A}=e (U_{A}, P) e (Q_{A}, P_{pub})^{-c}^{_{A}} and the proxy signature key S_{P} is described by S_{P}=c_{A}S_{B}+U_{A}.

6. The method of claim 5, wherein in the step (f) the proxy signature is (m, c_{P}, U_{P}, m_{w} and r_{A}), where m is the delegated message, where c_{P} equals H₁(m∥r_{P}), where U_{P} equals c_{P}S_{P}+k_{P}P, where r_{P} equals e(P, P)^{k}^{_{P}} and where k_{P} is an integer belonging to Z_{q}*.

7. The method of claim 6, wherein the verifying step (g) accepts the signature only if c_{P}=H₁(m∥r_{P}), where r_{P}=e (U_{P}, P) (e (Q_{A}+Q_{B}, P_{pub})^{H}^{₁}^{m}^{_{w}}^{∥r}^{_{A}}⁾·r_{A})^{-c}^{_{P}}.

8. An apparatus for generating and verifying an identity-based proxy signature by using bilinear pairings, comprising:
means for generating system parameters, selecting a master key and then disclosing the system parameters by a trust authority;
means for generating private keys of an original signer and a proxy signer based on the original signer's identity and proxy signer's identity, respectively, and then transferring the original signer's private key and proxy signer's private key to the original signer and proxy signer, respectively, through a secure channel by the trust authority;
means for receiving and storing the system parameters and the original signer's private key by the original signer, receiving and storing the system parameters and the proxy signer's private key by the proxy signer and receiving and storing the system parameters by a verifier;
means for generating a signed warrant, computing values for verifying the signature of the signed warrant by using at least one of the system parameters and transferring the signed warrant and the values to the proxy signer by the original signer;
means for verifying the signature of the signed warrant by using the values and an original signer's public key based on the original signer's identity and then generating a proxy signature key by the proxy signer;
means for proxy-signing a delegated message by using the proxy signature key by the proxy signer; and
means for verifying the validity of the proxy signature by using at least one of the system parameters and a proxy signer's public key based on the proxy signer's identity by the verifier.

9. The apparatus of claim 8, wherein the system parameters include G₁, G₂, e, q, P, P_{pub}, H₁ and H₂, where G₁ is a cyclic additive group whose order is a prime q, G₂ is a cyclic multiplicative group of the same order q, e is a bilinear paring defined by e: G₁×G₁→G₂, P is a generator of G₁, P_{pub} is a trust authority's public key having relationship of P_{pub}=s·P, where s is the master key, and H₁ and H₂ are hash functions, respectively, described by H₁: {0,1}*→Z_{q}* and H₂: {0,1}*→G₁, where Z_{q}* is a cyclic multiplicative group.

10. The apparatus of claim 9, wherein the original signer's public key Q_{A} equals H₂(A), where A is the original signer's identity, and the original signer's private key S_{A} equals s·Q_{A}; and
the proxy signer's public key Q_{B} equals H₂(B), where B is the proxy signer's identity, and the proxy signer's private key S_{B} equals S_{B}=s·Q_{B}.

11. The apparatus of claim 10, wherein the signed warrant m_{w} contains an explicit description of a delegation relation, the values for verifying the signature of the signed warrant (c_{A}, U_{A}) have the relationship of c_{A}=H₁(m_{w}∥r_{A}) and U_{A}=c_{A}S_{A}+kP, respectively, where r_{A} equals e(P, P)^{k} and k is an integer belonging to Z_{q}*.

12. The apparatus of claim 11, wherein the means for verifying the signature of the signed warrant accept the signature only if c_{A}=H₁(m_{w}∥r_{A}), where r_{A}=e (U_{A}, P) e (Q_{A}, P_{pub})^{-c}^{_{A}} and the proxy signature key S_{P} equals c_{A}S_{B}+U_{A}.

13. The apparatus of claim 12, wherein the proxy signature is (m, c_{P}, U_{P}, m_{w} and r_{A}), where m is the delegated message, where c_{P} equals H₁(m∥r_{P}), where U_{P} equals c_{P}S_{P}+k_{P}P, where r_{P} equals e(P, p)^{k}^{_{P}} and where k_{P} is an integer belonging to Z_{q}*.

14. The apparatus of claim 13, wherein the means for verifying the validity of the proxy signature accept the signature only if c_{P}=H₁(m∥r_{P}), where r_{P}=e (U_{P}, P) (e (Q_{A}+Q_{B}, P_{pub})^{H}^{₁}^{(m}^{_{w}}^{∥r}^{_{A}}⁾·r_{A})^{-c}^{_{P}}.
